(19) United States
(12) Patent Application Publication
(10) Pub. No.: US 2025/0209879 A1
(43) Pub. Date: Jun. 26, 2025

(54) METHOD AND DEVICE FOR MANAGING ENTERING AND LEAVING

(71) Applicant: TOYOTA JIDOSHA KABUSHIKI KAISHA, Aichi-ken (JP)

(72) Inventors: Yuta MORI, Urayasu-shi (JP); Hitoshi KAMADA, Setagaya-ku (JP); Koki SONE, Taito-ku (JP); Takahiro IWASAKI, Kiyose-shi (JP)

(21) Appl. No.: 18/979,603

(22) Filed: Dec. 13, 2024

(30) Foreign Application Priority Data
Dec. 20, 2023 (JP) 2023-215022

(51) Int. Cl. G07C 9/37; G06V 40/16

(52) U.S. Cl. CPC G07C 9/37; G06V 40/173

(57) ABSTRACT

A face image and an entire body image of an arbitrary person passing through a doorway are acquired using a camera image captured by a single camera provided near a doorway of a predetermined area. Entering of a management target into the predetermined area is detected by face authentication process using the face image of the arbitrary person included in the camera image and a registered face image of the management target. A feature quantity of the management of which entering into the predetermined area is detected is extracted. A feature quantity of the arbitrary person is extracted using the entire body image of the arbitrary person after the detection of the entering of the management target into the predetermined are. Leaving of the management target from the predetermined area is detected by re-identification process using the extracted feature quantity of the management target and that of the arbitrary person.

### CROSS-REFERENCE TO RELATED APPLICATION

The present application claims priority under 35 U.S.C. § 119 to Japanese Patent Application No. 2023-215022, filed on Dec. 20, 2023, the contents of which application are incorporated herein by reference in their entirety.

### TECHNICAL FIELD

The present disclosure relates to a method and a device for managing entering and leaving of a person to a predetermined area having a single doorway.

### BACKGROUND

JP2021152738A discloses an authentication device for a person entering a predetermined area having first and second doors. This authentication device performs a face authentication of a person by using a face image obtained by a first camera provided near a first door outside the predetermined area. When the face authentication is successful, the first door is unlocked, and an entire body information of a target person of the face authentication is acquired by the first camera. When the entire body information of the target person is acquired, an instruction to take a pose for registration in front of the first camera is issued to the person for whom the face authentication has succeeded. That is, the entire body information includes an entire body image of the person who has taken the registration pose.

In addition, when the entire body information of the person is acquired by a second camera provided near a second door inside the predetermined area, the authentication device compares the acquired entire body information with the entire body information acquired by the first camera. When the person takes near the second door the same pose as the pose for registration taken near the first door, an entire body information including an entire body image of the person who takes the pose for authentication is obtained. When a similarity between the pose for registration and that for authentication is equal to or greater than the threshold, the second door is unlocked.

Examples of documents showing a level of the technical field relating to the present disclosure include JP2010154134A in addition to JP2021152738A.

A case where entering and leaving of the same person to a predetermined area having a doorway is managed will be considered. Examples for managing such the entering and leaving include a method of detecting entering of a certain management target into the predetermined area and then detecting leaving of the management target from the predetermined area. Specifically, a camera is provided near the doorway to acquire a face image of a person, and face authentication is performed using the acquired face image. This makes it possible to detect entering of the management target into the predetermined area and leaving of the management target from the predetermined area.

However, when there is only one doorway, a travel direction of the person is opposite between entering and leaving, and thus a direction of the face of the person is not the same in most cases. Therefore, in the face authentication using the face image acquired from a single camera provided near the doorway, the entering of a person into the predetermined area or leaving of the same person from the predetermined area may not be detected.

In this regard, if two or more cameras are provided near the doorway, this problem can be solved. However, when there are some restrictions on where the camera can be installed, it may be possible to install only a single camera near the doorway. Therefore, it is desirable to develop a technology for realizing the detection of entering and leaving of the management target for the predetermined area having only a single doorway by using a single camera.

An object of the present disclosure is to provide a technique capable of realizing a detection of entering and leaving of a management target for a predetermined area having a single doorway by using a single camera.

### SUMMARY

A first aspect of the present disclosure is a method for managing entering and leaving of a management target for a predetermined area having a single doorway, the method comprising the following features.

The method comprises: acquiring a face image and an entire body image of an arbitrary person passing through the doorway using a camera image captured by a single camera installed near the doorway; detecting entering of the management target into the predetermined area by performing a face authentication process using the face image of the arbitrary person included in the camera image and a registered face image of the management target; extracting a feature quantity of the management target, of which entering into the predetermined area is detected by the face authentication process, from the entire body image of the management target included in the entire body image of the arbitrary person included in the camera image; extracting a feature quantity of the arbitrary person using the entire body image of the same arbitrary person included in the camera image after the detection of the entering of the management target into the predetermined area; and detecting leaving of the management target from the predetermined area by performing re-identification process using the feature quantity of the management target extracted based on the camera image and the feature quantity of the arbitrary person extracted based on the camera image.

A second aspect of the present disclosure is a device for managing entering and leaving of a management target for a predetermined area having a single doorway, the device comprising the following features.

The device includes one or more processors that perform various processes. The one or more processors are configured to acquire a face image and an entire body image of an arbitrary person passing through the doorway using a camera image captured by a single camera installed near the doorway; detect entering of the management target into the predetermined area by performing a face authentication process using the face image of the arbitrary person included in the camera image and a registered face image of the management target; extract a feature quantity of the management target, of which entering into the predetermined area is detected by the face authentication process, from the entire body image of the management target included in the entire body image of the arbitrary person included in the camera image; extract a feature quantity of the arbitrary person using the entire body image of the same arbitrary person included in the camera image after the detection of the entering of the management target into the predetermined area; and detect leaving of the management target from the predetermined area by performing re-identification process using the feature quantity of the management target extracted based on the camera image and the feature quantity of the arbitrary person extracted based on the camera image.

According to the present disclosure, the face image and the entire body image of the arbitrary person passing through the doorway are acquired by the single camera provided near the doorway of the predetermined area. Then, the face authentication process is performed using the acquired face image of the arbitrary person, and entering of the management target into the predetermined area is detected. Further, the extraction of the feature quantity using the acquired entire body image of the arbitrary person and the re-identification processing using the feature quantity are performed. The acquired entire body image of the arbitrary person includes the entire body image of the management target whose entering into the predetermined area is detected and the entire body image of the arbitrary person after the entrance of the management target into the predetermined area. Therefore, leaving of the management target from the predetermined area is detected by performing the re-identification processing. Therefore, it is possible to detect entering and leaving of the management target to the predetermined area having only the single doorway by using the single camera.

### BRIEF DESCRIPTION OF THE DRAWINGS

FIG. 1 is a diagram illustrating a configuration example of a management device according to a first embodiment and a configuration example of a predetermined area to which the management device is applied;

FIG. 2 is a diagram illustrating a viewpoint of the first embodiment;

FIG. 3 is a diagram for explaining a feature of the first embodiment;

FIG. 4 is a block diagram illustrating an example of a function configuration of a management device according to the first embodiment;

FIG. 5 is a diagram for explaining a feature of a second embodiment;

FIG. 6 is a block diagram illustrating an example of a function configuration of a management device according to the second embodiment;

FIG. 7 is a block diagram illustrating an example of a function configuration of a management device according to a third embodiment; and

FIG. 8 is a diagram for explaining a feature of a fourth embodiment.

### DESCRIPTION OF EMBODIMENT

Hereinafter, embodiments of the present disclosure will be described with reference to the drawings. In the drawings, the same or corresponding parts are denoted by the same reference numerals, and the description thereof will be simplified or omitted.

### 1. First Embodiment

### 1-1. Configuration Example

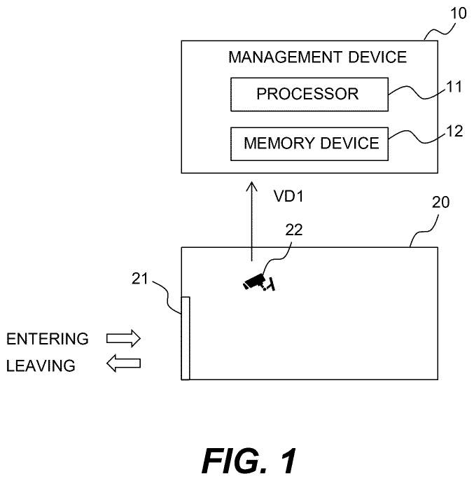

FIG. 1 is a diagram illustrating a configuration example of an entering and leaving management device according to a first embodiment and a configuration example of a predetermined area to which the entering and leaving management device is applied. A management device 10 illustrated in FIG. 1 is a management device according to the first embodiment. The management device 10 includes at least one processor 11 and at least one memory device 12. The processor 11 executes various processes. Examples of the processor 11 include a central processing unit (CPU), a graphics processing unit (GPU), application specific integrated circuits (ASICs), and a field-programmable gate array (FPGA). The memory device 12 stores various information. Examples of the memory device 12 include a volatile memory, a nonvolatile memory, a hard disk drive (HDD), and a solid-state drive (SSD).

The management device 10 is configured to be able to communicate with a camera 22 provided near a doorway 21 of a predetermined area 20. In the present disclosure, the predetermined area 20 means a space having a predetermined area. The space having a certain size may be a room provided in a facility (for example, a childcare facility or an education facility). The room and the path connected to the room are also examples of the space having a certain width. The space having a certain width may include a plurality of rooms. However, in the first embodiment, only the single camera 22 is provided in the doorway 21. The doorway 21 includes an entrance of a facility, a doorway of a room provided in the facility, and a doorway of a path connected to the room. A wired or wireless network is used as a communication network connecting the management device 10 and the camera 22.

In the example shown in FIG. 1, the camera 22 is provided inside the predetermined area 20. The camera 22 is attached to, for example, a ceiling surface or a side wall surface of the predetermined area 20. The camera 22 is oriented in a direction from the inside to the outside of the predetermined area 20. The imaging range of the camera 22 includes the entire doorway 21 and the floor surface near the doorway 21. According to the camera 22, it is possible to acquire a front image of an arbitrary person entering the predetermined area 20 through the doorway 21.

### 1-2. Feature of First Embodiment

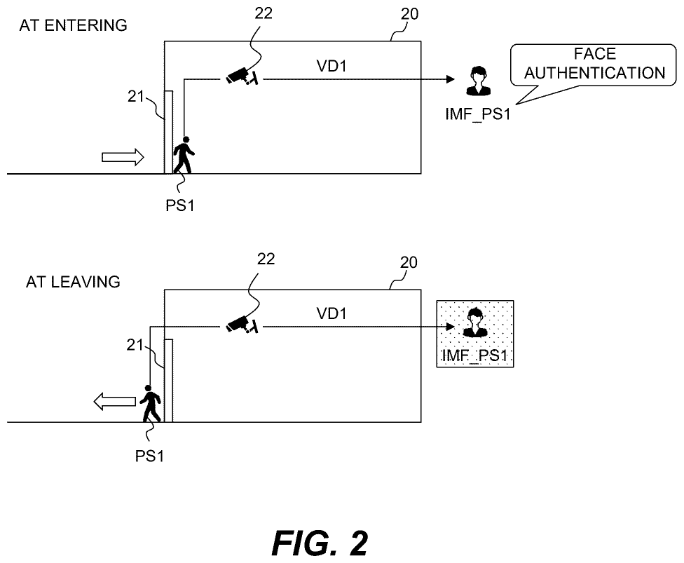

FIG. 2 is a diagram illustrating a viewpoint of the first embodiment. As described with reference to FIG. 1, the camera 22 can acquire a front image of an arbitrary person entering the predetermined area 20. Therefore, in the first embodiment, the face image IMF_VD1 of the arbitrary person PS1 is acquired from the camera image constituting the video PS1 acquired by the camera 22. Then, the face authentication process is performed using the face image IMF_PS1. In the face authentication process, the face image IMF_PS1 is compared with the face image IMF_PTs registered in advance. The face Image IMF_PT is of a person registered in advance (hereinafter, also referred to as a “management target PT”). When the face Image IMF_PS1 and the face Image IMG_PT match (for example, when the similarity between the two is equal to or greater than a threshold), it can be detected that the management target PT has entered the predetermined area 20.

However, the travel direction of the person PS1 when entering the predetermined area 20 through the doorway 21 is opposite to that when leaving the predetermined area 20 through the doorway 21. Therefore, in order to perform the above-described face authentication process for the purpose of detecting that the management target PT has left the predetermined area 20, a person passing through the doorway 21 is forced to perform a predetermined action (for example, a looking back action, an action of looking at the camera 22, or the like) for providing a face image to be compared with the face image IMF_PT.

Therefore, in the first embodiment, in order to detect that the management target PT has left the predetermined area 20, re-identification processing of a person is performed. Re-identification processing (Re-ID processing) of a person is a technique for identifying the same person from multiple images. In the person re-identification processing, a feature quantity of the person extracted from the video is used. The feature quantity is also referred to as a Re-ID feature quantity. The extraction of the Re-ID feature quantity is performed by applying a set of bounding boxes associated as representing the same person in a plurality of time steps to a Re-ID model based on machine learning, for example. Note that the extraction of the Re-ID feature quantity itself is a well-known technique, and the extraction method applied to the first embodiment is not particularly limited.

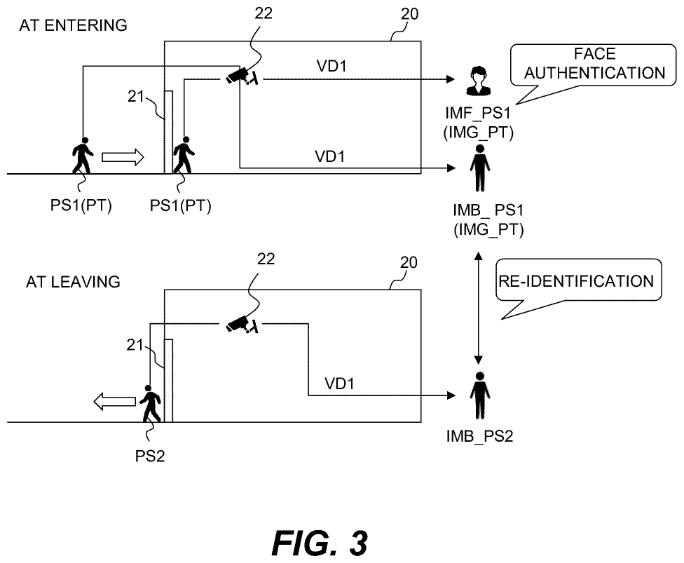

FIG. 3 is a diagram for explaining the feature of the first embodiment. To extract the Re-ID feature quantity of the management target PT, in the first embodiment, the entire body image IMB_PT of the management target PT in which entering into the predetermined area 20 is detected in the face authentication process is specified. The entire body image IMB_PT can be identified based on the camera image constituting the video VD1 at the time of entering the predetermined area 20 of the management target TP (for example, the time of passage of the doorway 21 by the management target TP, or the time immediately before or immediately after this passage time). The management target PT can be identified by extracting the Re-ID feature quantity of the management target PT.

In the first embodiment, the Re-ID feature quantity of the arbitrary person PS2 to leave is also extracted from the predetermined area 20. Then, re-identification processing is performed using the Re-ID feature quantity of the management target TP extracted at the time of entering the predetermined area 20 of the management target TP and the Re-ID feature quantity of the person PS2 extracted after the management target TP enters the predetermined area 20 (for example, after the time of passage of the doorway 21 by the management target TP). Thus, it is possible to detect that the management target PT has been left from the predetermined area 20.

As described above, according to the first embodiment, the re-identification processing of the person is performed in addition to the face authentication process. Therefore, the entering and leaving of the management target PT with respect to the predetermined area 20 having only the single doorway 21 can be detected by using the single camera 22.

### 1-3. Function Configuration Example

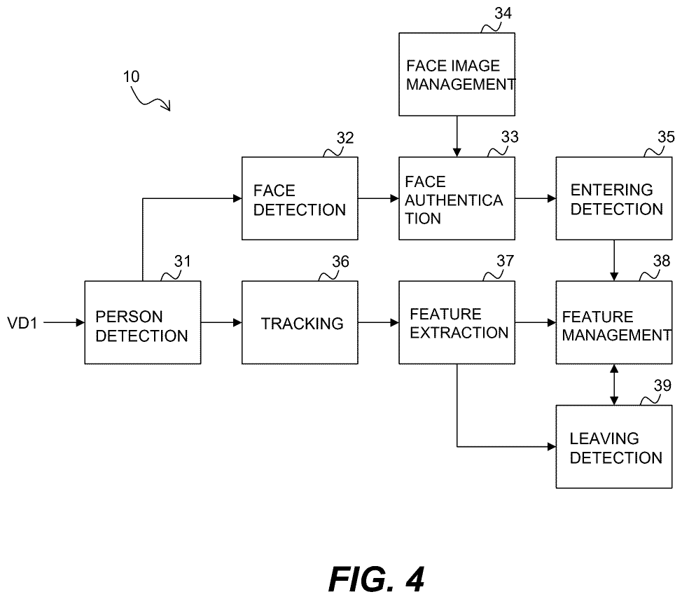

FIG. 4 is a block diagram illustrating an example of a function configuration of the management device 10 shown in FIG. 1. In the example shown in FIG. 4, the management device 10 includes a person detection portion 31, a face detection portion 32, a face authentication portion 33, a face image management portion 34, an entering detection portion 35, a tracking portion 36, a feature extraction portion 37, a feature management portion 38, and a leaving detection portion 39. These functions are implemented in a circuit or processing circuitry including, for example, a general-purpose processor, a special purpose processor, integrated circuits, ASICs, a CPU, conventional circuitry and/or combinations thereof programmed to perform these functions.

Here, the processor includes a transistor and other circuits and is regarded as a circuit or a processing circuit. The processor may be a program processor that executes a program stored in the memory. In the present disclosure, a circuit, unit, or means can be hardware programmed to perform the recited function or hardware to perform the function. The hardware may be any hardware disclosed herein or any hardware programmed to implement or known to perform the functions described above. Where hardware is the processor considered to be a type of circuit, the circuit, means or unit is a combination of hardware and software used to configure the hardware and/or processor.

The video VD1 acquired by the camera 22 is input to the person detection portion 31. The person detection portion 31 performs person detection processing for detecting a person VD1 in camera images of a plurality of time steps included in a video PS1. In the person detection processing, a bounding box is assigned to the person PS1 in each camera image. The bounding box represents the location of the person PS1 detected in the camera image. In the person detection processing, information of the bounding box assigned to the person PS1 in each camera image is acquired. The bounding box is added to the image of the face portion of the person PS1 or the entire body image of the person PS1. The person detection processing is a well-known technique, and the method thereof is not particularly limited. For example, an YOLOX is applied to the person detection portion 31.

The information of the bounding box is input to the face detection portion 32 from the person detection portion 31. The face detection portion 32 performs face detection processing for detecting the face image of the person PS1 based on the information of the bounding box. In a case where the bounding box is added to the image of the face portion of the person PS1 in the person detection processing, the bounding box information is flowed in the face detection processing. When the bounding box is added to the image of the entire body of the person PS1 in the person detection processing, the image of the face portion is extracted from the image of the entire body in the face detection processing.

The face authentication portion 33 receives the face image of the person PS1 (for example, face image IMF_SP1) from the face detection portion 32. The face authentication portion 33 performs a face authentication process using the face image and a face image (for example, face image IMF_TP) of the management target TP stored in the face image management portion 34 (that is, the memory device 12). In the face authentication process, the face Image IMF_SP1 and the face Image IMF_TP are collated. If the two match, it is determined that the person PS1 is the same person as the management target TP. The face authentication portion 33 sends the verification result to the entering detection portion 35. The collation result includes determination information for the face Image IMF_SP1 and attached information of the face Image IMF_SP1. If the person PS1 is determined to be the management target TP, the determination information includes identification information of the management target TP. The attached information includes identification information of the camera 22 that has acquired the face Image IMF_SP1, and coordinate information and time stamp information of the face Image IMF_SP1.

The matching result from the face authentication portion 33 is input to the entering detection portion 35. The entering detection portion 35 detects entering of the management target TP based on the determination information included in the collation result. When the entering of the management target TP is detected, the entering detection portion 35 outputs the detection information of the entering of the management target TP to the feature management portion 38 together with the attached information included in the collation result.

The tracking portion 36 receives information of the bounding box from the person detection portion 31. The tracking portion 36 performs tracking processing of the person PS1 based on the information of the bounding box. The tracking process is a technique of automatically tracking the same person included in the camera image based on a tracking algorithm. In the tracking process, in particular, a plurality of bounding boxes representing the same person (that is, person PS1) in a plurality of time steps are associated with each other. Thus, information representing a time series of a plurality of bounding boxes is generated. The tracking process itself is a well-known technique, and the method is not particularly limited.

A set of a plurality of bounding boxes associated with each other as representing the same person is input from the tracking portion 36 to the feature extraction portion 37. The feature extraction portion 37 performs extraction processing for extracting the Re-ID feature quantity of the same person (that is, person PS1) based on the set of bounding boxes. The extraction processing is performed using, for example, a Re-ID model. The Re-ID model is, for example, a model based on a transformer.

The information of the Re-ID feature quantity is input to the feature management portion 38 from the feature extraction portion 37. The feature management portion 38 stores the input information from the feature extraction portion 37 in the memory device 12. The feature management portion 38 also receives the entering detection information of the management target TP and the attached information included in the matching result from the entering detection portion 35. The feature management portion 38 specifies the Re-ID feature quantity corresponding to the Re-ID feature quantity of the management target TP among the Re-ID feature quantities included in the input information from the feature extraction portion 37 based on the input information from the entering detection portion 35. The identification of the Re-ID feature quantity of the management target TP can be performed using, for example, the attached information included in the collation result, and the coordinate information and the time stamp information of the bounding box which is the target of the extraction of the Re-ID feature quantity. Information of the Re-ID feature quantity of the specified management target TP is stored in the memory device 12.

Information of the Re-ID feature quantity of the person PS2 is input to the leaving management portion 39 from the feature extraction portion 37. The leaving management portion 39 performs re-identification processing of the management target TP using the input information from the feature extraction portion 37 and the Re-ID feature quantity of the management target TP stored in the feature management portion 38 (the memory device 12). In this re-identification processing, the Re-ID feature quantity of the person PS2 input from the feature extraction portion 37 is compared with the Re-ID feature quantity of the management target TP stored in the feature management portion 38. If the two match (for example, if the similarity between the two is equal to or greater than a threshold), the leaving management portion 39 detects leaving of the TP of the management target.

### 2. Second Embodiment

### 2-1. Feature of Second Embodiment

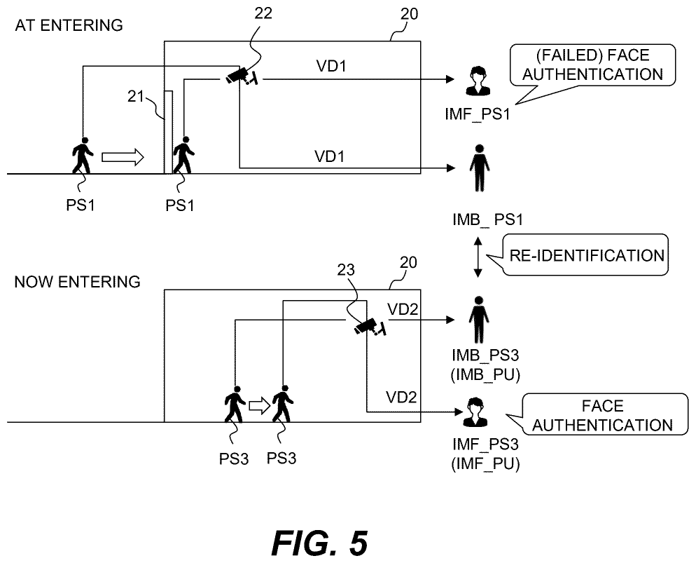

FIG. 5 is a diagram illustrating a feature of a second embodiment of the present disclosure. In the first embodiment, the face authentication process using the face Image IMF_PS1 and the face Image IMF_TP is performed, and thus the entering of the management target TP into the predetermined area 20 is detected. However, if the face image IMF_PS1 is unclear, the face authentication process is not performed correctly. Then, although the management target TP enters the predetermined area 20, the entering is not detected. In addition, if the face authentication process is not correctly performed, the Re-ID feature quantity of the management target TP is not specified based on the collation result of the face authentication process. Therefore, leaving from the predetermined area 20 of the management target TP is not detected.

Therefore, in the second embodiment, the camera 23 different from the camera 22 is used as a sub-camera, and the face image IMF_PU of the unauthenticated persons PU is acquired from the camera image constituting the video VD2 acquired by the camera 23. Like the camera 22, the camera 23 is provided inside the predetermined area 20. The camera 23 is oriented in the predetermined area 20. A part of the imaging range of the camera 23 may overlap the imaging range of the camera 22. The total number of cameras 23 is at least one.

The unauthenticated persons PU is a person VD1 that is not authenticated in the face authentication process using the camera image constituting the video PS1. The unauthenticated persons PU are identified by re-identification processing of persons. In this re-identification processing, the Re-ID feature quantity of the person VD1 extracted based on the camera image constituting the video PS1 is compared with that of the arbitrary person VD2 extracted based on the camera image constituting the video PS3. If the two match (for example, if the similarity between the two is equal to or greater than a threshold), it is determined that person PS1 is the same person as person PS3.

When it is determined that person PS1 corresponds to unauthenticated persons PU and person PS1 is the same person as person PS3, person PS3 corresponds to unauthenticated persons PU. Therefore, in the second embodiment, the face authentication process is performed using the face image IMF_PS3 of the person PS3 as the face image IMF_PU. In the face authentication process, the face Image IMF_PU and the face Image IMF_PT are collated. As described above, in the second embodiment, additional re-identification processing using the camera image constituting the video VD2 and an additional face authentication process are performed.

In the second embodiment, when it is detected that the management target TP enters the predetermined area 20 as a result of the additional face authentication process, the entire body image IMB_VD2 is specified based on the camera image constituting the video PT at the time of this detection (for example, at the time before or after the detection of the entering of the management target TP). Then, the Re-ID feature quantity of the management target PT is extracted from the entire body image IMB_PT, and the re-identification processing of the person is performed. This re-identification processing is the same as the processing performed in the first embodiment.

As described above, according to the second embodiment, the entire body image IMB_VD2 necessary for the additional re-identification processing using the camera image constituting the video PT, the additional face authentication process, and the re-identification processing for detecting leaving of the management target TP is specified. Therefore, even when the face authentication process of the management target TP using the camera image constituting the video VD1 fails, entering and leaving of the management target TP with respect to the predetermined area 20 can be detected.

### 2-2. Function Configuration Example

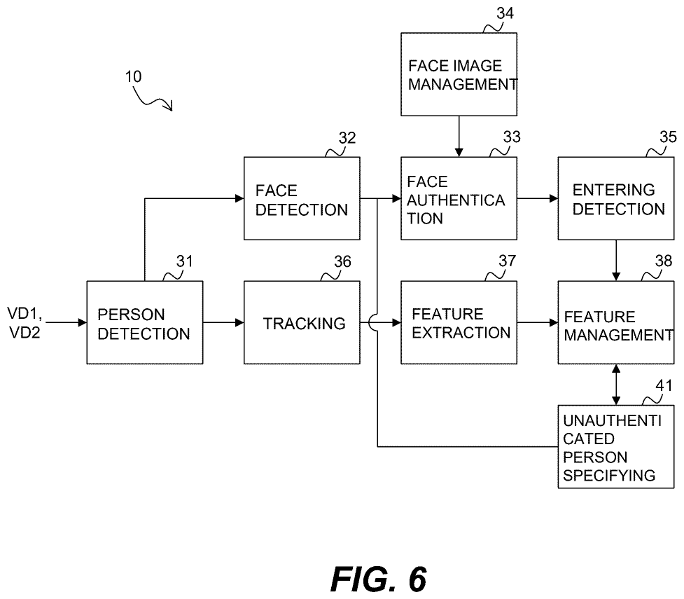

FIG. 6 is a block diagram illustrating an example of a function configuration of the management device 10 related to the second embodiment. In the example illustrated in FIG. 6, the management device 10 includes an unauthenticated person specifying portion 41 in addition to the person detection portion 31 to the feature management portion 38 illustrated in FIG. 4. The leaving detection portion 39 is omitted for convenience of explanation. The difference between FIG. 4 and FIG. 6 is that an unauthenticated person specifying portion 41 is added and that the video VD1 and VD2 are input to the person detection portion 31. However, various processes such as the face authentication process and the tracking process using the video VD2 are basically the same as the various processes using the video VD1 described in FIG. 4. Therefore, functions particularly related to the second embodiment will be described below.

The matching result from the face authentication portion 33 is input to the entering detection portion 35. The entering detection portion 35 detects entering of the TP of the management target based on the determination information included in the collation result. The process up to this point is the same as that of the first embodiment. In the second embodiment, when the face image IMF_TP that matches the face image IMF_SP1 is not present in the face image management portion 34, information indicating that the person PS1 corresponds to the unauthenticated persons PU is added to the determination information of the face image IMF_SP1. When the information of the unauthenticated persons PU is included in the determination information, the entering detection portion 35 outputs the information of the unauthenticated persons PU to the feature management portion 38 together with the attached information included in the verification result.

The feature management portion 38 specifies the Re-ID feature quantity corresponding to the Re-ID feature quantity of the unauthenticated persons PU among the Re-ID feature quantities included in the input information from the feature extraction portion 37 based on the input information from the entering detection portion 35. The identification of the Re-ID feature quantity of the unauthenticated persons PU can be performed using, for example, the attached information included in the verification result, and the coordinate information and the time stamp information of the bounding box that is the target of the extraction of the Re-ID feature quantity. Information of the Re-ID feature quantity of the identified unauthenticated persons PU is stored in the memory device 12.

The unauthenticated persons specifying portion 41 performs re-identification processing of the unauthenticated persons PU using the Re-ID feature quantity of the unauthenticated persons PU stored in the feature management portion 38 (the memory device 12) and the Re-ID feature quantity of the person PS3 stored in the feature management portion 38. In the re-identification processing, the Re-ID feature quantity of the unauthenticated persons PU and the Re-ID feature quantity of the person PS3 are compared. When the two match, the unauthenticated persons identification unit 41 determines that person PS3 corresponds to unauthenticated persons PU. Then, the unauthenticated persons identification unit 41 outputs a command of the face authentication process using the face Image IMF_PS3 to the face authentication portion 33.

When the command of the face authentication process is input, the face authentication portion 33 performs the face authentication process using the face image IMF_PS3 (for example, the face image IMF_TU) and the face image (for example, the face image IMF_TP) of the management target TP stored in the face image management portion 34 (that is, the memory device 12). In the face authentication process, the face Image IMF_SP3 and the face Image IMF_TP are collated. If the two match, it is determined that the person PS3 is the same person as the management target TP.

### 3. Third Embodiment

### 3-1. Feature of Third Embodiment

In the first embodiment, the Re-ID feature quantity of the management target TP is extracted from the camera image constituting the video VD1 at the time of entering the predetermined area 20 of the management target TP, and the Re-ID feature quantity of the arbitrary person VD1 leaving the predetermined area 20 is extracted from the camera image constituting the video PS2 after entering the predetermined area 20 of the management target TP. In the first embodiment, re-identification processing using the Re-ID feature quantity of the management target TP and the Re-ID feature quantity of the person PS2 is further performed. Therefore, by comparing these Re-ID feature quantities, it is possible to detect that the management target PT has been left from the predetermined area 20.

However, even if the management target TP is the same person as the person PS2, the similarity of the Re-ID feature quantity may be low. For example, when the management target TP changes clothes in the predetermined area 20, the clothes of the management target TP are different between the time of entering and the time of leaving. Then, it is not possible to detect that the management target PT has left the predetermined area 20.

Therefore, in the third embodiment, the re-identification processing of the management target TP is performed using the Re-ID feature quantity of the management target TP extracted based on the camera image constituting the video VD1 and the Re-ID feature quantity of the person VD2 extracted based on the camera image constituting the video PS3. In this re-identification processing, the Re-ID feature quantity of the management target TP is compared with that of the person PS3. If the two match (for example, if the similarity between the two is equal to or greater than a threshold), it is determined that the person PS3 is the same person as the management target TP. Since it is assumed that the similarity of the Re-ID feature quantity is low, the threshold used in the re-identification processing of the management target TP may be set to a value lower than the threshold of the re-identification processing performed in the leaving management of the first embodiment.

By performing such re-identification processing of the management target TP, it is possible to continue to specify the management target TP in the predetermined area 20. Therefore, even when the management target TP is changed in the predetermined area 20, it is possible to detect that the management target TP is leaving the predetermined area 20 by continuously tracking the management target TP in the predetermined area 20.

### 3-2. Function Configuration Example

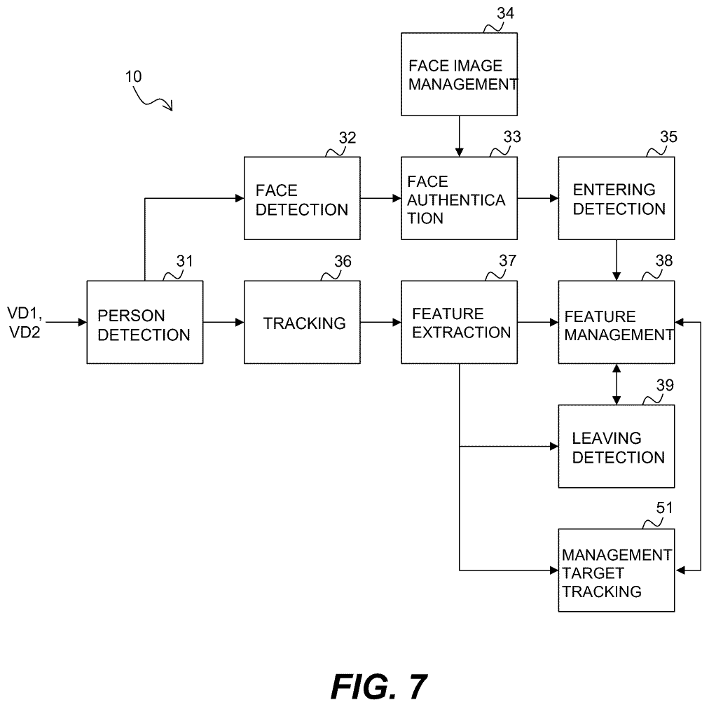

FIG. 7 is a block diagram illustrating an example of a function configuration of the management device 10 related to the third embodiment. In the example shown in FIG. 7, the management device 10 includes a management target tracking portion 51 in addition to the person detection portion 31 to the leaving detection portion 39 shown in FIG. 4. The difference between FIG. 4 and FIG. 7 is that a management target tracking portion 51 is added and the video VD1 and VD2 are input to the person detection portion 31. However, various processes such as the face authentication process and the tracking process using the video VD2 are basically the same as the various processes using the video VD1 described in FIG. 4. Therefore, functions particularly related to the third embodiment will be described below.

The management target tracking portion 51 receives information of the Re-ID feature quantity of the person PS3 from the feature extraction portion 37. The management target tracking portion 51 performs re-identification processing of the management target TP using the input information from the feature extraction portion 37 and the Re-ID feature quantity of the management target TP stored in the feature management portion 38 (the memory device 12). In this re-identification processing, the Re-ID feature quantity of the person PS3 input from the feature extraction portion 37 is compared with the Re-ID feature quantity of the management target TP stored in the feature management portion 38. If the two match, it is determined that the person PS3 is the same person as the management target TP. If the person PS3 is determined to be the same person as the management target TP, the management target tracking portion 51 outputs this determination information to the feature management portion 38.

The feature management portion 38 receives the determination information from the management target tracking portion 51. The feature management portion 38 stores the input information from the management target tracking portion 51 in the memory device 12. If the person PS3 is determined to be the same person as the management target TP, the Re-ID feature quantity of the person PS3 is specified as the Re-ID feature quantity of the management target TP and stored in the memory device 12.

Information of the Re-ID feature quantity of the person PS2 is input to the leaving management portion 39 from the feature extraction portion 37. The leaving management portion 39 performs re-identification processing of the management target TP using the input information from the feature extraction portion 37 and the Re-ID feature quantity of the management target TP stored in the feature management portion 38 (the memory device 12). In this re-identification processing, the Re-ID feature quantity of the person PS2 input from the feature extraction portion 37 is compared with the Re-ID feature quantity of the management target TP stored in the feature management portion 38. When it is determined that the person PS3 is the same person as the management target TP, the information of the Re-ID feature quantity of the management target TP stored in the feature management portion 38 is updated by the Re-ID feature quantity of the person PS3.

### 4. Fourth Embodiment

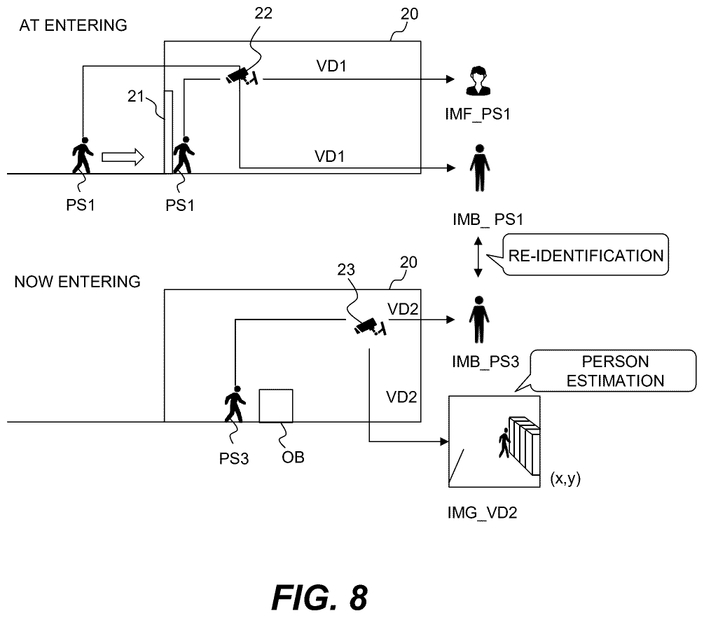

FIG. 8 is a diagram illustrating a feature of a fourth embodiment of the present disclosure. In the third embodiment, to specify the management target TP in the predetermined area 20, the Re-ID feature quantity of the person VD2 extracted based on the camera image constituting the video PS3 is extracted. Then, when the Re-ID feature quantity of the person PS3 matches that of the management target TP extracted based on the camera image constituting the video VD1, it is determined that the person PS3 is the same person as the management target TP.

However, when there are many candidates having a possibility of being the same person as the management target TP, it is difficult to specify the management target TP by the re-identification processing of the management target TP in the predetermined area 20. In particular, in facilities such as a childcare facility and an educational facility, it is expected that the person P3 and the management target TP are younger. In this case, there is a possibility that the person PS3 is erroneously determined to be the same person as the management target TP.

Therefore, in the fourth embodiment, the monopoly OB (for example, a personal locker) of the management target TP installed in the predetermined area 20 is photographed by the camera 23. By including the installation location of the monopoly OB in the imaging range of the camera 23, the image of the monopoly OB is included in the camera image IMG_VD2 constituting the video VD2 acquired by the camera 23. In the fourth embodiment, when the image of the person VD2 is included in the camera image IMG_P3, the distances between the representative coordinates of the image of the person P3 and the representative coordinates (known) of the image of the monopoly OB are calculated. If the distances between the representative coordinates are within the predetermined distances, the person P3 photographed by the camera 23 is estimated to be the same person as the management target TP.

In this way, in the fourth embodiment, estimate processing of the person VD2 is performed based on the distances between the representative coordinates of the image of the monopoly OB on the camera image IMG_P3 and the representative coordinates of the image of the person P3. When the person P3 is estimated, candidates having a possibility of being the same person as the management target TP are narrowed down. Therefore, by adding the result of the estimate processing to the information of the Re-ID feature quantity of the person PS3, it is possible to suppress the person PS3 from being erroneously determined to be the same person as the management target TP.

What is claimed is:

1. A method for managing entering and leaving of a management target for a predetermined area having a single doorway, the method comprising:
acquiring a face image and an entire body image of an arbitrary person passing through the doorway using a camera image captured by a single camera installed near the doorway;
detecting entering of the management target into the predetermined area by performing a face authentication process using the face image of the arbitrary person included in the camera image and a registered face image of the management target;
extracting a feature quantity of the management target, of which entering into the predetermined area is detected by the face authentication process, from the entire body image of the management target included in the entire body image of the arbitrary person included in the camera image;
extracting a feature quantity of the arbitrary person using the entire body image of the same arbitrary person included in the camera image after the detection of the entering of the management target into the predetermined area; and
detecting leaving of the management target from the predetermined area by performing re-identification process using the feature quantity of the management target extracted based on the camera image and the feature quantity of the arbitrary person extracted based on the camera image.

2. The method according to claim 1, further comprising:
acquiring an entire body image of an arbitrary person existing in the predetermined area using a sub-camera image captured by at least one sub-camera provided in the predetermined area;
extracting a feature quantity of the arbitrary person by using the entire body image of the same arbitrary person included in the sub-camera image;
extracting a feature quantity of an unauthenticated person indicating a person who is not authenticated in the face authentication process by using the entire body image of the same unauthenticated person from the entire body image of the arbitrary person included in the camera image;
performing re-identification process using the feature quantity of the arbitrary person extracted based on the sub-camera image and the feature quantity of the unauthenticated person extracted based on the camera image to identify the unauthenticated person existing in the predetermined area; and
performing an additional face authentication process using the face image of the identified unauthenticated person and the registered face image of the management target when the unauthenticated person is identified and the face image of the identified unauthenticated person is included in the sub-camera image,
wherein, in the additional face authentication process, when the face image of the identified unauthenticated person and the registered face image of the management target are identical, entering into the predetermined area by the management target is detected.

3. The method of claim 1, further comprising:
acquiring an entire body image of an arbitrary person existing in the predetermined area using a sub-camera image captured by at least one sub-camera provided in the predetermined area;
extracting a feature quantity of the arbitrary person by using the entire body image of the same arbitrary person included in the sub-camera image after the detection of the entering of the management target into the predetermined area;
performing re-identification process using the feature quantity of the management target extracted based on the camera image and the feature quantity of the arbitrary person extracted based on the sub-camera image to identify the management target existing in the predetermined area; and
tracking the identified management target when the management target is identified in the re-identification process.

4. The method according to claim 1, further comprising:
acquiring an entire body image of an arbitrary person existing in the predetermined area using a sub-camera image captured by at least one sub-camera provided in the predetermined area; and
estimating the arbitrary person based on a coordinate on the sub-camera image of an image of the arbitrary person included in the sub-camera image after the detection of the entering of the management target into the predetermined area,
wherein an imaging range of the sub-camera includes a monopoly of the management target installed inside or outside the predetermined area, and
wherein, when a distance from the coordinate of the image of the arbitrary person on the sub-camera image to the coordinate of an installation location of the monopoly in the sub-camera image is equal to or less than a predetermined distance, the same arbitrary person is estimated to be the management target corresponding to the monopoly.

5. A device for managing entering and leaving of a management target for a predetermined area having a single doorway, the device comprising:
one or more processors configured to perform various processes,
wherein the one or more processors are configured to:
acquire a face image and an entire body image of an arbitrary person passing through the doorway by using a camera image captured by a single camera provided near the doorway;
detect entering of the management target into the predetermined area by performing a face authentication process using the face image of the arbitrary person included in the camera image and a registered face image of the management target;
extract a feature quantity of the management target, of which entering into the predetermined area is detected by the face authentication process, from the entire body image of the management target included in the entire body image of the arbitrary person included in the camera image;
extract a feature quantity of the arbitrary person using the entire body image of the arbitrary included in the camera image after the detection of the entering of the management target into the predetermined area; and
detect leaving of the management target from the predetermined area by performing re-identification process using the feature quantity of the management target extracted based on the camera image and the feature quantity of the arbitrary person extracted based on the camera image.
